(19) United States
(12) Patent Application Publication
(10) Pub. No.: US 2012/0079445 A1
(43) Pub. Date: Mar. 29, 2012

(54) CIRCUIT BOARD DESIGNING DEVICE AND NON-TRANSITORY COMPUTER-READABLE MEDIUM

(75) Inventors: Masato Ariyama, Kawasaki (JP); Kazuhiro Sakai, Kawasaki (JP)

(73) Assignee: FUJITSU LIMITED, Kawasaki-shi (JP)

(21) Appl. No.: 13/215,486

(22) Filed: Aug. 23, 2011

(30) Foreign Application Priority Data
Sep. 24, 2010 (JP) 2010-214434

(51) Int. Cl. G06F 17/50

(52) U.S. Cl. 716/122

(57) ABSTRACT

A circuit board designing device has a database that stores an another-component arrangement forbidden range table, a related component information table, and a relative-arranging position table, and a processing unit that executes arrangement of the components, determines the another-component arrangement forbidden range which is set to forbid arrangement of another component in the predetermined range on the basis of the arranging position of the basic component with reference to the another-component arrangement forbidden range table when arrangement of the basic component is instructed, acquires related component information corresponding to the related component to be combined with the basic components with reference to the related component information table, acquires a relative-arranging position of the related component from the relative-arranging position table on the basis of the acquired related component information, and sets the acquired related component in the another-component arrangement forbidden range when a predetermined condition is satisfied.

### CROSS-REFERENCE TO RELATED APPLICATION

This application is based upon and claims the benefit of priority of the prior Japanese Patent Application No. 2010-214434, filed on Sep. 24, 2010, the entire contents of which are incorporated herein by reference.

### FIELD

The present art relates to a circuit board designing device and a circuit board designing program.

### BACKGROUND

Hitherto, there has been proposed a circuit board designing device of the type that in arrangement of components, any one of components is set as an arranging object component and the step of arranging each arranging object component is repeatedly performed to arrange all the components on a circuit board. In the above mentioned circuit board designing device, the arranging position of each component is determined on the basis of net connectivity information. Then, whether arrangement of a component is permitted is judged using an area which is set in the component and in which arrangement of another component is forbidden (hereinafter, referred to as an another-component arrangement forbidden area) based on whether the component interferes with another component in arrangement of components.

There exists a combined component obtained by combining a plurality of related components with one another to form one component having one function. In the case that components are to be arranged on the basis of connectivity information, information indicating a relative positional relation among the components included in the combined component is not present. In the circuit board designing device, each combined component is defined as one piece of component information. Therefore, in general, the circuit board designing device does not have component arrangement information on each related component within the combined component. Thus, it is difficult for the circuit board designing device to arrange the combined component at a position where the combined component operates as one component having one function with no positional displacement among the related components.

As a technique adopted when arranging a combined component, there is proposed a technique of preparing a library of the combined component in which related components are integrated together on the basis of design data of the related components. However, the above technique may make it difficult to mount, on a printed board for inspection, related components one by one which will serve as original data for a component mounting machine and an appearance inspecting machine.

In addition, a technique of storing each of components included in a combined component into related component information like ordinary components may be conceived of. However, each related component includes an area occupied by the related component and an another-component arrangement forbidden area which is prepared to avoid interference of the related component with other components. Therefore, there is also proposed a technique of aligning a part of an arrangement forbidden area of a main component with an occupied area of each related component, hollowing out an overlapped area and setting the hollowed-out area as an arrangement forbidden area in arranging a combined component. However, this technique has such a problem that a different component having the same size may be arranged in the hollowed-out area, and thus the components may be erroneously arranged.

Japanese Laid-open Patent Publication No. 04-242484 is an example of related art.

### SUMMARY

According to an aspect of an invention, a circuit board designing device has a database that stores an another-component arrangement forbidden range table indicating an another-component arrangement forbidden range which is set to forbid arrangement of another component in a predetermined range on the basis of a basic component to be arranged on a circuit board, a related component information table indicating information on each related component to be arranged on the circuit board in combination with the basic component, and a relative-arranging position table indicating an arranging position of the related component relative to the basic component, and a processing unit that executes arrangement of the components, wherein the processing unit determines the another-component arrangement forbidden range which is set to forbid arrangement of another component in the predetermined range on the basis of the arranging position of the basic component with reference to the another-component arrangement forbidden range table when arrangement of the basic component is instructed, acquires related component information corresponding to the related component to be combined with the basic components with reference to the related component information table, acquires a relative-arranging position of the related component from the relative-arranging position table on the basis of the acquired related component information, and sets the acquired related component, arrangement of which is permitted, in the another-component arrangement forbidden range when a predetermined condition is satisfied even in the case that the acquired relative-arranging position is within the another-component arrangement forbidden range of the basic component.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a circuit board designing device.

FIG. 2 is a diagram illustrating an example of arrangement of a combined component.

FIG. 3 is a diagram illustrating an example of a logical management table.

FIG. 4 is a diagram illustrating an example of a physical management table.

FIG. 5 is a diagram illustrating an example of a flowchart (the first half part) of a component arranging process.

FIG. 6 is a diagram illustrating an example of the flowchart (the second half part) of the component arranging process.

FIG. 7 is a diagram illustrating an example of arrangement of a combined component.

FIG. 8 is a diagram illustrating an example of a logical management table.

FIG. 9 is a diagram illustrating an example of a physical management table.

FIG. 10 is a diagram illustrating an example of an integrated management table.

FIG. 11 is a diagram illustrating functional blocks of a computer.

### DESCRIPTION OF EMBODIMENTS

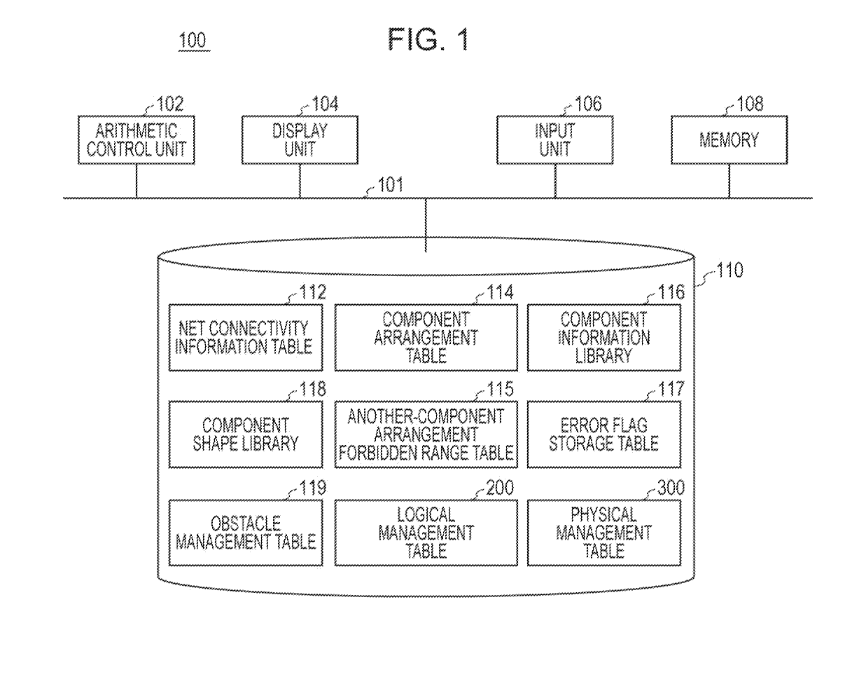

FIG. 1 is a diagram illustrating an example of a configuration of a circuit board designing device 100 according to an embodiment. The circuit board designing device 100 includes an arithmetic control unit 102 that controls programs and data, and an input unit 106 that an operator operates to activate a program and to respond to the program. The circuit board designing device 100 further includes a display unit 104 that displays a layout of a circuit board, and the input unit 106 that the operator also operates to select and move a mounting object component being displayed on the display unit 104. The circuit board designing device 100 further includes a memory 108 where the arithmetic control unit 102 expands a component arrangement program and a component information database 110 that stores component information such as the shape of each component and the like. The arithmetic control unit 102, the display unit 104, the input unit 106, the memory 108 and the component information database 110 are connected with one another via a bus 101.

The component information database 110 includes a net connectivity information table 112 that records arranging positions of components, a component arrangement table 114 that records arrangement information on components mounted on a circuit board, and a component information library 116 that records component information. The component information database 110 further includes a component shape library 118 that records the shape of each component, an another-component arrangement forbidden range table 115 that defines an another-component arrangement forbidden area of each component to be arranged, and an error flag storage table 117 that stores an error flag that the arithmetic control unit 102 sets ON when interference has occurred in the another-component arrangement forbidden area. The component information database 110 further includes an obstacle management table 119 that registers a component the arranging position of which has been decided, a logical management table 200 that records logical relevancy for managing a combining object component, and a physical management table 300 that records physical relevancy for managing the relative position of a component to be combined to a main component.

The arithmetic control unit 102 expands the component arrangement program in the memory 108 to execute the component arrangement program. The arithmetic control unit 102 executes control of checking whether interference with another component occurs. Specifically, the arithmetic control unit 102 executes control of judging whether a component that an operator has selected is a combined component with reference to the logical management table 200. The arithmetic control unit 102 acquires the coordinates of a relative position of the combined component to a main component from the physical management table 300 on the basis of a management key with reference to the logical management table 200. The combined component includes the main component and appended components. The arithmetic control unit 102 guides the combined component so as to facilitate arrangement of the component at the origin of the main component. In the case that all the arrangement coordinates, arrangement angle, and arrangement surface of the combined component are decided, the arithmetic control unit 102 collectively arranges combination mating components.

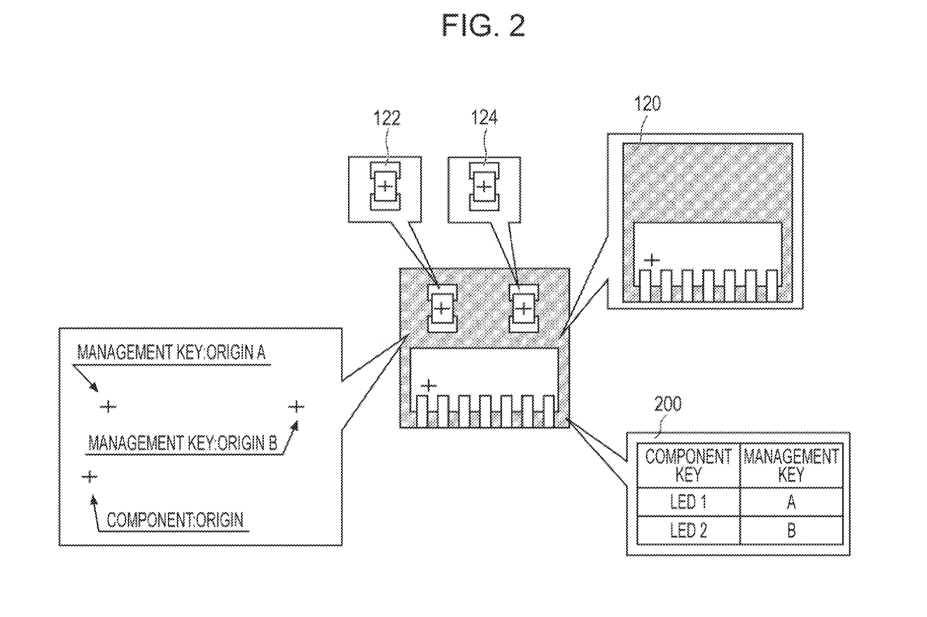

FIG. 2 is a diagram illustrating an example of arrangement of a combined component according to an embodiment. In the embodiment, an example will be described in which a component including a connector and two LEDs is arranged as a combined component on a circuit board. Here, in the combined component, the connector corresponds to the main component and the LEDs correspond to the appended components.

Connector component shape data 120 includes a meshed another-component arrangement forbidden range and the origin coordinates of the connector. The origin coordinates of the connector are as indicated by “+” in the connector component shape data 120. Only a component that matches a component key which is defined in the logical management table 200 is guided to the arrangement origin as an appended component on the basis of a management key and in accordance with the physical management table 300. As a result, arrangement of the appended component in the another-component arrangement forbidden range is allowed. In the combined component illustrated in FIG. 2, the management keys of an LED1 and an LED2 which are the appended components of the connector are defined in the logical management table 200. Therefore, the operator is allowed to arrange first LED component shape data 122 and second LED component shape data 124 in the another-component arrangement forbidden range in the connector component shape data 120. The position of “+” indicated in the first LED component shape data 122 indicates the origin coordinates of the first LED1 and the position of “+” indicated in the second LED component shape data 124 indicates the origin coordinates of the second LED2.

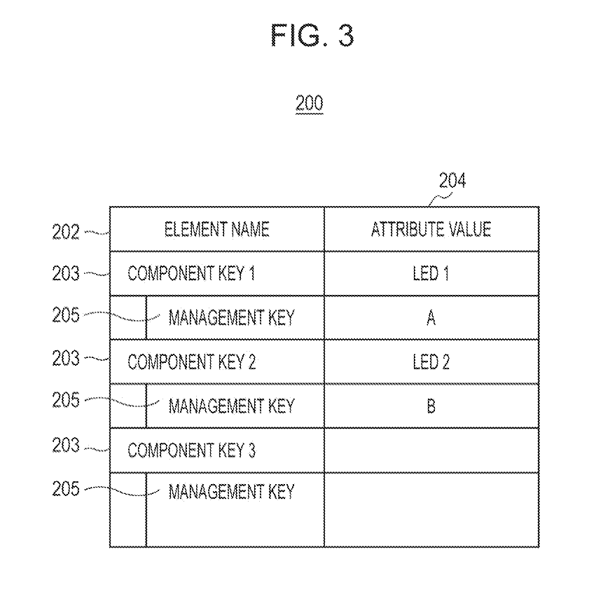

FIG. 3 is a diagram illustrating an example of a structure of the logical management table 200. The logical management table 200 includes the fields of an element name 202 and attribute values 204. The element name 202 includes the fields of component keys 203 and management keys 205. Each component key 203 is unique identification information which is added in order to identify each component. Each management key 205 is unique identification information which is added in order to identify the relative position of each combining object component. The arithmetic control unit 102 manages the components one by one with reference to the logical management table 200. Each component key 203 is a key that identifies the mating component of the combined component. For example, the model number of each component to be ordered, each circuit component number in a printed board, the location number of each component, the component shape data number of each component, or the like may be given as the component key.

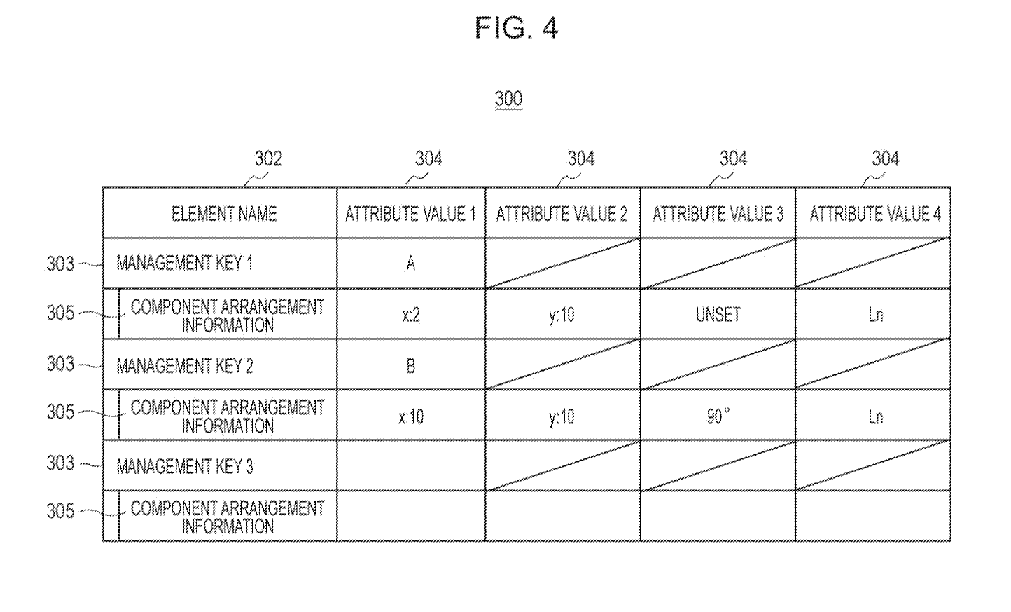

FIG. 4 is a diagram illustrating an example of a structure of the physical management table 300. The physical management table 300 includes the fields of an element name 302 and attribute values 304. The element name 302 includes the fields of management keys 303 and component arrangement information 305. The arithmetic control unit 102 manages the components one by one with reference to the physical management table 300. Here, for example, the model number of each component to be ordered, each circuit component number in a printed board, the location number of each component, the component shape data number of each component, or the like may be used to manage the components one by one. The component arrangement information is information on the scheduled arranging position of each appended component, relative to a main component, to be arranged in a circuit board in combination with the main component. The component arrangement information indicates the arranging position of the appended component that matches the management key relative to the main component and has a structure that defines the arrangement X-coordinate (an attribute value 1) of each component, the arrangement Y-coordinate (an attribute value 2) of each component, the arrangement angle (an attribute value 3) of each component, and the mounting surface (an attribute value 4) of each component. Here, the mounting surface of a component which is to be built in the board is indicated by an object layer. In the example in FIG. 4, the component arrangement angle which is the attribute value 3 of the component arrangement information of a management key 1 is “unset”. The arrangement angle is set in the case that it is intended to optimally arrange a component at an angle of, for example, 90 degrees or 270 degrees based on the net connectivity information, and therefore an attribute value is not necessarily set. Accordingly, when a particular arrangement angle is not intended, the value is “unset”.

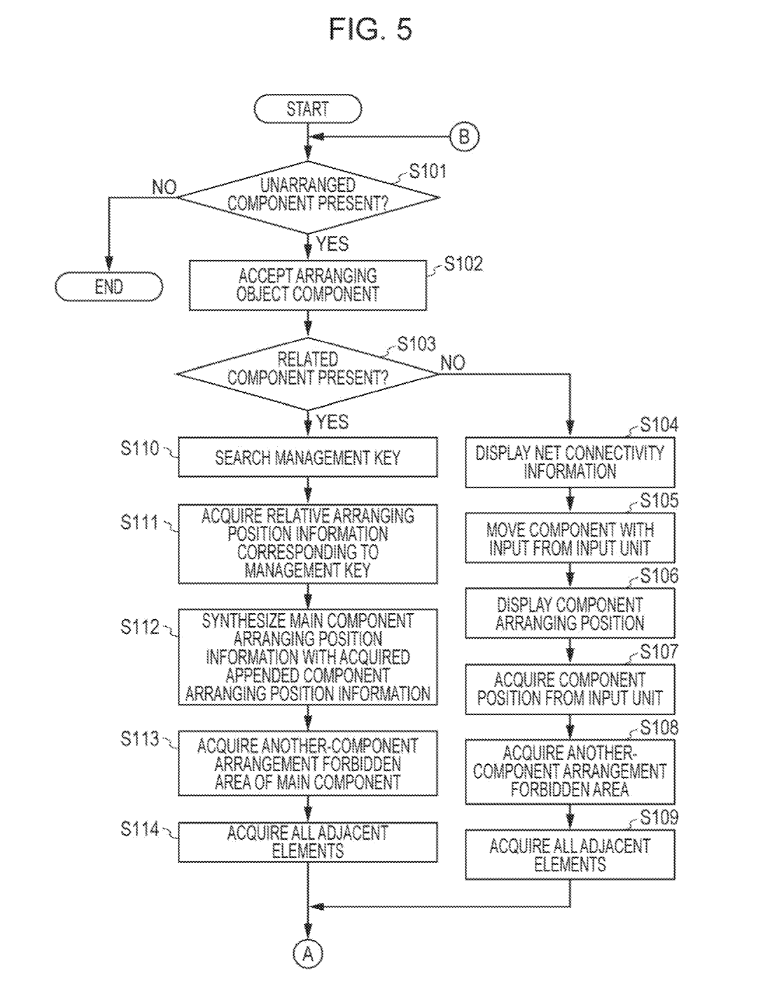

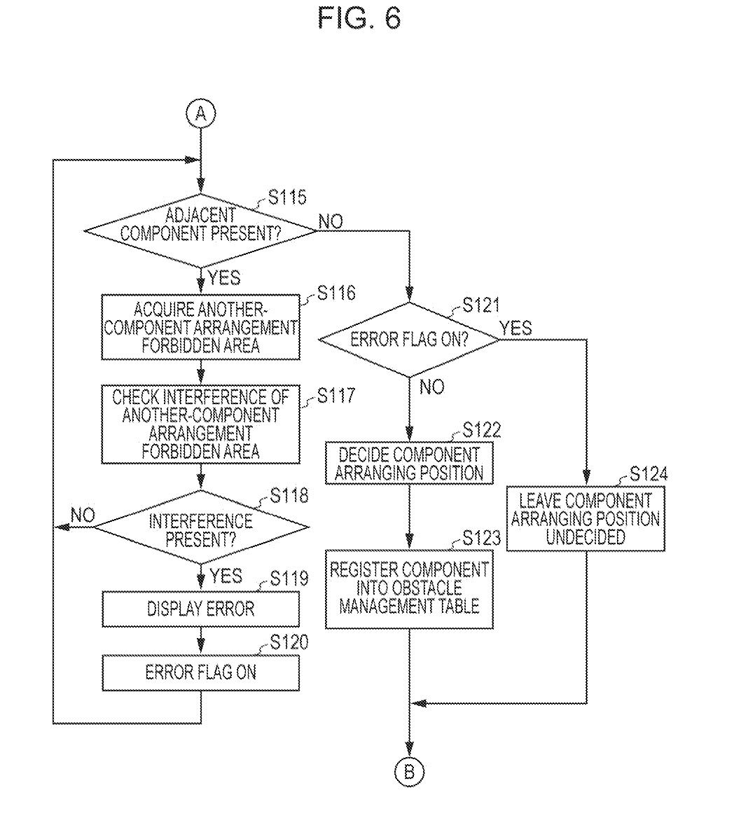

Next, a component arranging process to be executed using the circuit board designing device 100 according to the embodiment will be described with reference to FIG. 5 and FIG. 6.

At step S101, the arithmetic control unit 102 judges whether an unarranged component is present. Specifically, in the case that an operator selects an unarranged component and determines its arrangement, the arithmetic control unit 102 stores a flag corresponding to the unarranged component into the component arrangement table 114. The arithmetic control unit 102 judges whether an unarranged component is present with reference to the flag in the component arrangement table 114. When the unarranged component is present, the process proceeds to step S102. While, when there is no component to be arranged, the process is terminated.

At step S102, when the operator selects a component to be arranged as an arranging object among unarranged components using the input unit 106, the arithmetic control unit 102 accepts the selected component as the arranging object component. When the operator operates the input unit 106 to move the arranging object component on the display unit 104, the arithmetic control unit 102 moves the arranging object component on the display unit 104 under the operation of the operator. The arithmetic control unit 102 acquires the position coordinates of the arranging object component on the display unit 104 with the operator moving the arranging object component. Then, the process proceeds to step S103.

At step S103, the arithmetic control unit 102 judges whether the arranging object component is a combining object component with reference to the logical management table 200. The arithmetic control unit 102 judges whether an instruction to arrange the main component in the combined component has been received from the operator. When the arranging object component is the combining object component, the process proceeds to step S110. While, when the arranging object component is not the combining object component, the process proceeds to step S104.

At step S104, the arithmetic control unit 102 displays the net connectivity information on the pin of a component which is in connecting relation with the pin of the arranging object component on the display unit 104 with reference to the net connectivity information table 112. Then, the process proceeds to step S105.

At step S105, the arithmetic control unit 102 displays the arranging object component on the display unit 104 in response to input from the input unit 106 by the operator and also displays the net connectivity information with movement of the arranging object component. Then, the process proceeds to step S106.

At step S106, the arithmetic control unit 102 displays the arranging position of the arranging object component on the display unit 104. Then, the process proceeds to step S107.

At step S107, the arithmetic control unit 102 acquires the position information of the arranging object component from the input unit 106. The arithmetic control unit 102 acquires the reference pin coordinates, the arranging surface, the rotation angle, and the like of the arranging object component as the position information. Then, the process proceeds to step S108.

At step S108, the arithmetic control unit 102 acquires the another-component arrangement forbidden range of the arranging object component from the another-component arrangement forbidden range table 115. Then, the process proceeds to step S109.

At step S109, the arithmetic control unit 102 acquires an adjacent element with reference to the obstacle management table 119. Then, the process proceeds to step S115 in FIG. 6.

At step S115 in FIG. 6, the arithmetic control unit 102 judges whether the adjacent component (element) is present. The flag corresponding to the adjacent element which has been acquired at step S109 is stored into the component arrangement table 114. The arithmetic control unit 102 judges whether the adjacent component is present with reference to the flag in the component arrangement table 114. When the adjacent component is present, the process proceeds to step S116. While, when there is no adjacent component, the process proceeds to step S121.

At step S116, the arithmetic control unit 102 acquires the another-component arrangement forbidden range regarding the adjacent component from the another-component arrangement forbidden range table 115. Then, the process proceeds to step S117.

At step S117, the arithmetic control unit 102 checks interference of the another-component arrangement forbidden range. The arithmetic control unit 102 checks interference by judging whether the shape of the arranged component which has been acquired from the component shape library 118 overlaps the another-component arrangement forbidden range of the adjacent component which has been acquired at step S116. Then, the process proceeds to step S118.

At step S118, the arithmetic control unit 102 judges whether interference of the another-component arrangement forbidden range is observed. When interference of the another-component arrangement forbidden range is observed, the process proceeds to step S119. While, when interference of the another-component arrangement forbidden range is not observed, the process returns to step S115.

At step S119, the arithmetic control unit 102 highlights the another-component arrangement forbidden range on the display unit 104 to display an error on the display unit 104. Then, the process proceeds to S120.

At step S120, the arithmetic control unit 102 sets the error flag in the error flag storage table 1170N because of presence of the another-component arrangement forbidden range. Then, the process returns to step S115.

Next, a case will be described in which it has been judged at step S115 that the adjacent component is not present.

At step S121, the arithmetic control unit 102 judges whether the error flag is ON with reference to the error flag storage table 117. When the error flag is ON, the process proceeds to step S124. While, when the error flag is not ON, the process proceeds to step S122.

At step S122, the arithmetic control unit 102 decides the arranging position of the adjacent component. Then, the process proceeds to step S123.

At step S123, the arithmetic control unit 102 registers the component into the obstacle management table 119. Then, the process returns to step S101 in FIG. 5.

At step S124, the arithmetic control unit 102 leaves the component arranging position undecided and the process returns to the step S105 in FIG. 5 in this state. That is, the process proceeds to step S101 in a state in which the object component is left unarranged.

At step S110, the arithmetic control unit 102 receives an instruction to arrange an appended component in the combined component from the operator and searches for a management key in the physical management table 300 corresponding to a management key in the logical management table 200 with reference to the logical management table 200. Then, the arithmetic control unit 102 judges whether arrangement of the appended component in the another-component arrangement forbidden range of the main component is allowed. Then, the process proceeds to step S111.

At step S111, the arithmetic control unit 102 acquires the relative-arranging position information of the appended component corresponding to the management key with reference to the physical management table 300. Then, the process proceeds to step S112.

At step S112, the arithmetic control unit 102 synthesizes the arranging position information of the main component which has been arranged with the arranging position information of the appended component to be combined with the main component. The arithmetic control unit 102 permits arrangement of the appended component at the scheduled arranging position in the another-component arrangement forbidden range. Then, the process proceeds to step S113.

At step S113, the arithmetic control unit 102 determines the another-component arrangement forbidden range of the main component with reference to the another-component arrangement forbiddance table 117. Then, the process proceeds to step S114.

At step S144, the arithmetic control unit 102 acquires an adjacent component from the obstacle management table 119. Then, the process proceeds to step S115 in FIG. 6.

Then, the arithmetic control units 102 repetitively executes the process of step S115 and subsequent steps and outputs a result of arrangement of the main component and the appended components on the circuit board to the display unit 104 at step S122.

In the above mentioned embodiment, the logical management table and the physical management table are provided for a component serving as a “master” and the logical information and physical information of components serving as “slaves” are set in the tables on condition that the components included in the combined component stand in the relation of master and slaves. That is, the connector in the combined component is regarded as the “master” component (a parent component) and the LED1 and LED2 which are combination mating components to be appended to the master component are regarded as the “slave” components (under the parent component), and the above components are managed using the logical management table 200 and the physical management table 300 under the above mentioned condition. However, it may also be possible to prepare the logical management table and the physical management table by regarding these components as the components that belong to the hierarchy of the same level without standing them in advance in the relation of master and slaves. In the above mentioned case, the logical management table and the physical management table are not provided for the parent component and are provided independently. Then, when the component keys of these components match with one other, the components are managed as one combined component. Accordingly, in the embodiment, it may become possible to manage the combination mating components by arranging the LED1 and the LED2 in advance without depending on pre-arrangement of the connector.

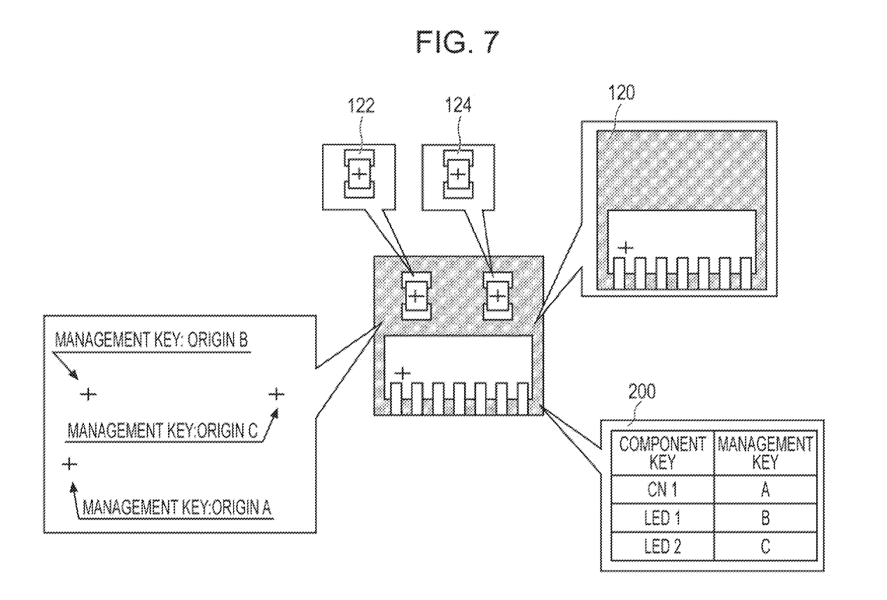

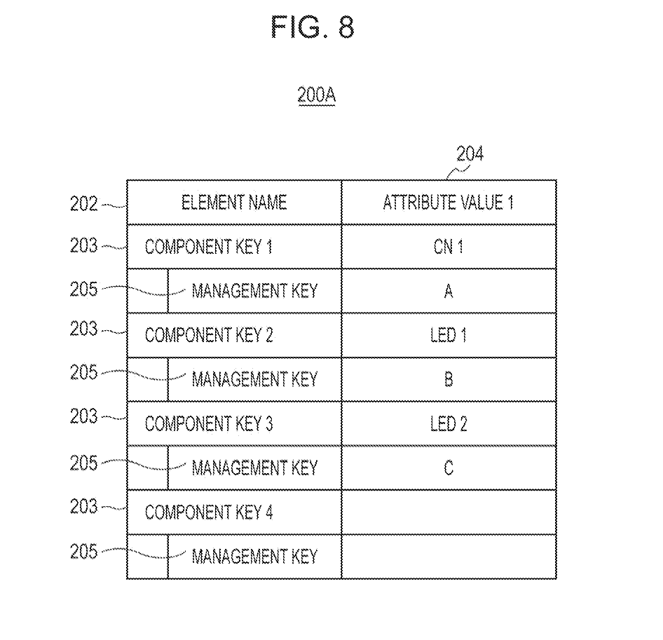

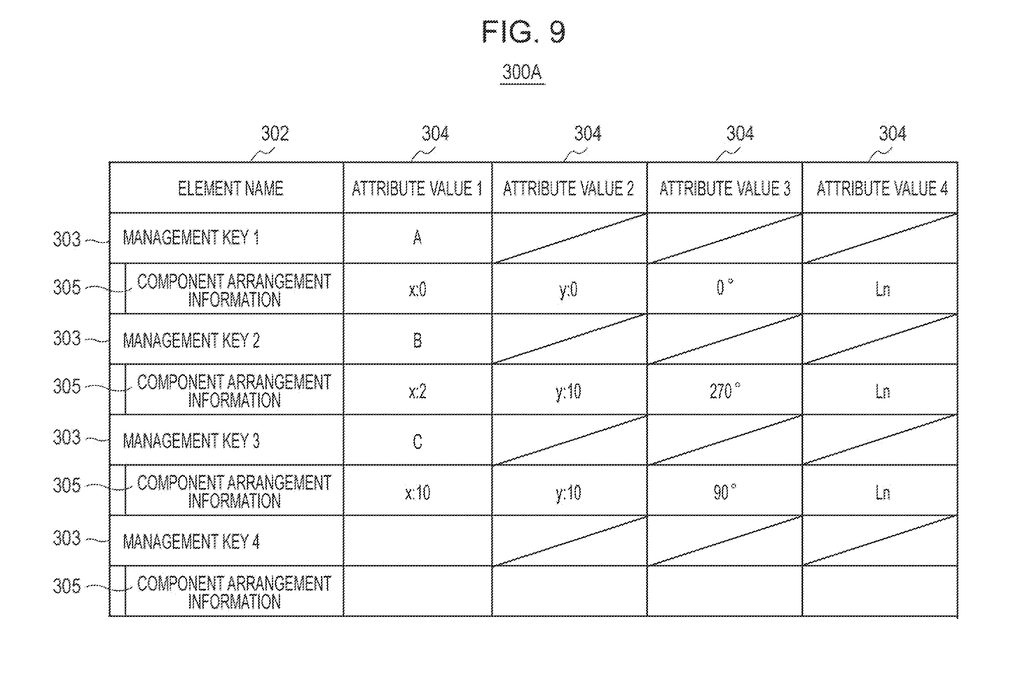

An example of arrangement of a combined component according to the embodiment is illustrated in FIG. 7, an example of a logical management table 200A is illustrated in FIG. 8, and an example of a physical management table 300A is illustrated in FIG. 9.

As illustrated in FIG. 7, an example of the embodiment will be described in which a component including a connector and two LEDs is arranged on a circuit board as a combined component. The logical management table 200A includes the connector as the component key.

As illustrated in the example in FIG. 8, the logical management table 200A includes the attribute information of the connector as “Component Key 1” 203. In addition, as illustrated in the example in FIG. 9, the physical management table 300A includes component arrangement information corresponding to “Management Key A” 205 of the connector. In the case, if component arrangement is started from the LED2 of “Management Key C” 205, the component corresponding to the connector will be guided to the relative position on the X-coordinate “−10” and the Y-coordinate “−10” when viewed from the LED2.

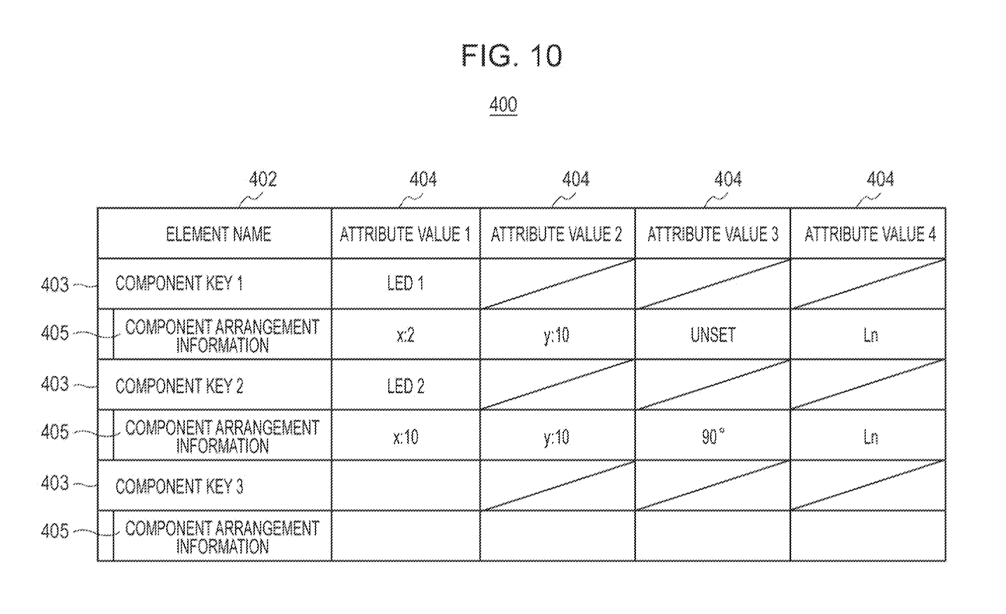

In addition, although the logical management table is prepared separately from the physical management table in the above mentioned embodiments, it may be possible to manage the components using an integrated management table 400 in which the management keys are omitted and the logical information is integrated with the physical information as illustrated in FIG. 10. The integrated management table 400 includes component keys 403 and component arrangement information 405 in the fields of an element name 402 and also includes attribute values 404.

According to the embodiments, it may become easy to arrange components at relative positions where the components are combined into one component so as to exhibit its function by defining in advance the mating components to be used in combination and their arranging positions in the management table. As a result, troublesome alignment to be performed when components are individually arranged in an editor may be eliminated and the design quality may be increased by avoiding errors in arranging positions.

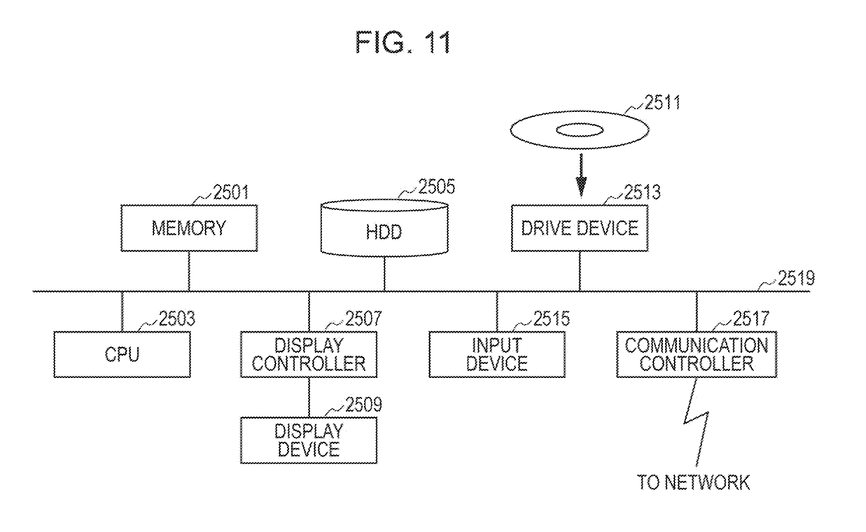

As illustrated in FIG. 11, a memory 2501 (storage unit), a central processing unit (CPU) 2503 (processor), a hard disk drive (HDD) 2505, a display controller 2507 connected to a display device 2509, a drive device 2513 for a removable disk 2511, an input device 2515, and a communication controller 2517 for connecting to a network are connected by a bus 2519. An operating system (OS) and application programs including a web browser are stored in the HDD 2505, and when executed by the CPU 2503, the OS and the application programs are read out to the memory 2501 from the HDD 2505. The CPU 2503 controls the display controller 2507, the communication controller 2517, and the drive device 2513 as necessary to cause the display controller 2507, the communication controller 2517, and the drive device 2513 to perform necessary operations. In addition, data being processed is stored in the memory 2501, and may be stored in the HDD 2505 as necessary. Such a computer realizes the various functions described above through organic and cooperative operation of hardware such as the CPU 2503 and the memory 2501, the OS, and necessary application programs, which are described above.

The information of a component which is to be a combining object is defined in the logical management table and the physical management table. Only a component whose attribute value matches the key value in the logical management table may be guided in accordance with the physical management table as a combination mating component when its arrangement origin is decided based on its attribute value, and then the component is arranged even in the arrangement forbidden area. A limited component arrangement permitted range is set, in the physical management table, for a component other than the combining object component and the range is regarded as the arrangement forbidden area where arrangement of the component is not permitted. In addition, according to the embodiment, arrangement of the combined component may be allowed regardless of presence of the arrangement forbidden area by preparing in advance the arrangement forbidden area or the limited component arrangement permitted range in the component shape data for the combination mating component arranging positions, and erroneous arrangement of another component at a position in the above area or range is prevented. Therefore, the design quality may also be increased by avoiding erroneous arrangement of another component. In addition, it may become possible to check whether the combined component is arranged in a predetermined range when the coordinates are not uniquely defined by preparing an error range or by designating a range without fixing the coordinates.

In the above-described embodiments, a combined component including a connector and LEDs has been described, but the art is not limited thereto. For example, the following components may be available as the combined components.

As another combined component, for example, a mini SAS multi-port connector is available. A two-port type mini SAS multi-port connector is arranged while maintaining a positional relation between two SMD connectors to be connected with a board and one cage (rack) in order to receive a mating connector.

As further another combined component, for example, an SFP/XFP multi-coupling optical module is available. When an optical pipe of an LED is attached to the SFP/XFP, the entire surface of a connector is illuminated with light which is emitted from the LED disposed at the rear of the connector through the optical pipe. In such SFP/XFP combined component that includes an optical module cage (rack) and optical module SMD connectors to be connected with a board and has a structure as mentioned above, when two LED optical pipes are prepared for one optical module, one cage, four SMD connectors and eight LEDs are arranged while maintaining a positional relation therebetween.

According to embodiments, when an instruction to arrange an appended component included in a combined component is received, whether arrangement of the appended component in an another-component arrangement forbidden range is allowed is judged with reference to a table that stores a scheduled arranging position of a previously-defined appended component relative to a main component. Then, when arrangement of the appended component in the another-component arrangement forbidden range is allowed, arrangement of the appended component at the scheduled arranging position in the another-component arrangement forbidden range is permitted. Therefore, even when another component has the same size as a component to be arranged, arrangement of another component in the another-component arrangement forbidden range of the main component is not allowed unless it is defined in the table. Thus, erroneous arrangement of another component may be avoided.

As illustrated in FIG. 11, a memory 2501 (storage unit), a central processing unit (CPU) 2503 (processor), a hard disk drive (HDD) 2505, a display controller 2507 connected to a display device 2509, a drive device 2513 for a removable disk 2511, an input device 2515, and a communication controller 2517 for connecting to a network are connected by a bus 2519. An operating system (OS) and application programs including a web browser are stored in the HDD 2505, and when executed by the CPU 2503, the OS and the application programs are read out to the memory 2501 from the HDD 2505. The CPU 2503 controls the display controller 2507, the communication controller 2517, and the drive device 2513 as necessary to cause the display controller 2507, the communication controller 2517, and the drive device 2513 to perform necessary operations. In addition, data being processed is stored in the memory 2501, and may be stored in the HDD 2505 as necessary. Such a computer realizes the various functions described above through organic and cooperative operation of hardware such as the CPU 2503 and the memory 2501, the OS, and necessary application programs, which are described above.

As mentioned above, the present invention has been specifically described for better understanding of the embodiments thereof and the above description does not limit other aspects of the invention. Therefore, the present invention can be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A circuit board designing device comprising:
a database that stores an another-component arrangement forbidden range table indicating an another-component arrangement forbidden range which is set to forbid arrangement of another component in a predetermined range on the basis of a basic component to be arranged on a circuit board, a related component information table indicating information on each related component to be arranged on the circuit board in combination with the basic component, and a relative-arranging position table indicating an arranging position of the related component relative to the basic component; and
a processing unit that determines the another-component arrangement forbidden range which is set to forbid arrangement of another component in the predetermined range on the basis of the arranging position of the basic component with reference to the another-component arrangement forbidden range table when arrangement of the basic component is instructed, acquires related component information corresponding to the related component to be combined with the basic components with reference to the related component information table, acquires a relative-arranging position of the related component from the relative-arranging position table on the basis of the acquired related component information, and sets the acquired related component, arrangement of which is permitted, in the another-component arrangement forbidden range when a predetermined condition is satisfied even in the case that the acquired relative-arranging position is within the another-component arrangement forbidden range of the basic component.

2. The circuit board designing device according to claim 1, wherein
the processing unit judges whether arrangement of the related component in the another-component arrangement forbidden range is allowed by comparing the position of the related component with the relative-arranging position.

3. A circuit board designing device comprising:
a component arrangement table that stores an arranging position of a first component to be arranged on a circuit board, and an arranging position of a second component to be arranged in combination with the first component; and
a processing unit that arranges the second component with reference to the component arrangement table, arranges the first component after the second component has been arranged on the basis of a relative position of the first component to the second component which has been calculated with reference to the component arrangement table, determines an another-component arrangement forbidden range which is set to forbid arrangement of another component in a predetermined range on the basis of the first component, and outputs a result of arrangement of the first component and the second component on the circuit board.

4. A non-transitory, computer-readable storage medium storing a circuit board designing program that causes a computer, which is accessible to a storage unit that stores an another-component arrangement forbidden range table indicating an another-component arrangement forbidden range which is set to forbid arrangement of another component in a predetermined range on the basis of a basic component to be arranged on a circuit board, to execute a process comprising:
determining the another-component arrangement forbidden range which is set to forbid arrangement of another component in the predetermined range on the basis of an arranging position of the basic component with reference to the another-component arrangement forbidden range table when arrangement of the basic component is instructed;
acquiring information on each related component to be combined with the basic component with reference to a related component information table indicating information on each related component to be arranged on the circuit board in combination with the basic component;
acquiring a relative-arranging position of the related component from a relative-arranging position table indicating a relative-arranging position of the related component to the basic component on the basis of the acquired related component information; and
setting the acquired related component, arrangement of which is permitted, in the another-component arrangement forbidden range when a predetermined condition is satisfied even in the case that the acquired relative-arranging position is within the another-component arrangement forbidden range of the basic component.

5. The non-transitory, computer-readable storage medium according to claim 4, wherein it is judged whether arrangement of the related component in the another-component arrangement forbidden range is allowed by comparing the position of the related component with the relative-arranging position.
